(19) United States
(12) Patent Application Publication
(10) Pub. No.: US 2026/0087626 A1
(43) Pub. Date: Mar. 26, 2026

(54) TEAR VOLUME MEASUREMENTS WITH A HEAD MOUNTED DEVICE

(71) Applicant: Apple Inc., Cupertino, CA (US)

(72) Inventors: Jay C. MUNG, San Jose, CA (US); Emmanuel B. ALABI, San Diego, CA (US); Laura L. WALKER, Orinda, CA (US)

(21) Appl. No.: 19/333,061

(22) Filed: Sep. 18, 2025

Related U.S. Application Data
(60) Provisional application No. 63/699,793, filed on Sep. 26, 2024.

(51) Int. Cl. G06T 7/00; G06F 3/01; G06T 7/62; G06T 7/70

(52) U.S. Cl. CPC G06T 7/0014; G06F 3/013; G06T 7/62; G06T 7/70; G06T 2207/20081; G06T 2207/30041

(57) ABSTRACT

The present disclosure is generally direct to an electronic device that, in accordance with a determination that one or more first criteria are satisfied, obtains, via the one or more cameras, a plurality of images, where the plurality of images includes one or more eyes of a user of the electronic device. Further, in accordance with a determination that one or more second criteria are satisfied, the electronic device determines a tear volume measurement for one or more of the plurality of images of the one or more eyes of the user. Moreover, in accordance with a determination that one or more third criteria are satisfied, including a criterion that is satisfied when the tear volume measurement is below a tear volume threshold, the electronic device determines a dry-eye condition associated with the one or more eyes of the user.

### CROSS REFERENCE TO RELATED APPLICATIONS

This application claims the benefit of U.S. Provisional Application No. 63/699,793, filed Sep. 26, 2024, the content of which is herein incorporated by reference in its entirety for all purposes.

### FIELD OF THE DISCLOSURE

This relates generally to systems and methods for measuring tear volume, and more specifically, to measuring tear volume in support of physiological screenings such as for a dry-eye condition for a user of an electronic device.

### BACKGROUND OF THE DISCLOSURE

The use of wearable computing devices with eye tracking sensors has increased recently. Wearable computing devices take images of the eyes using cameras and use the images to track the direction the eyes are looking in a three-dimensional environment.

### SUMMARY OF THE DISCLOSURE

Described herein are systems and methods for determining tear volume of the eyes of a user of an electronic device using image data obtained by one or more cameras. The image data of one or more eyes can be used to determine a tear volume measurement. The tear volume measurement can be used, in some examples, to detect a dry-eye condition of the user. In some examples of the disclosure, an electronic device (such as a head-mounted device) includes one or more cameras that are positioned to take one or more images of the eyes of the user of the electronic device. In one or more examples, in accordance with a determination that one or more first criteria are satisfied, the electronic device obtains, via the one or more cameras, an image or a plurality of images. The image or the plurality of images includes one or more eyes of a user of the electronic device.

In one or more examples, using the obtained images of the one or more eyes of the user, the electronic device determines a tear volume measurement of the user of the electronic device. In one or more examples, the electronic device determines a tear meniscus height value of the one or more eyes of the user and uses the determined tear meniscus height value to determine the tear volume measurement. In one or more examples, when the electronic device determines that one or more criteria are satisfied, including a criterion that is satisfied when the tear volume measurement is below a tear volume threshold, the electronic device determines a dry-eye condition associated with the one or more eyes of the user of the electronic device. In one or more examples, the electronic device notifies the user of a possible dry-eye condition and/or suggests mitigations or follow-up for diagnosis with a health care provider.

In some examples, the electronic device applies one or more processing algorithms/techniques to the obtained images to determine the tear meniscus height value, including but not limited to, one or more image segmentation algorithms and/or one or more image processing algorithms. In one or more examples, the electronic device obtains the one or more images of the eyes in accordance with a determination that the eyes of the user are in a particular state, such as after a blink of the eyes or after (or within) a pre-determined amount of time has passed after a blink of the eyes has occurred. Additionally or alternatively, in one or more examples, the electronic device obtains the images of the eyes in accordance with one or more environmental conditions being satisfied.

The full descriptions of these examples are provided in the Drawings and the Detailed Description, and it is understood that this Summary does not limit the scope of the disclosure in any way.

### BRIEF DESCRIPTION OF THE DRAWINGS

For improved understanding of the various examples described herein, reference should be made to the Detailed Description below along with the following drawings. Like reference numerals often refer to corresponding parts throughout the drawings.

FIG. 1 illustrates an electronic device presenting an extended reality environment according to some examples of the disclosure.

FIG. 2 illustrates a block diagram of an example architecture for a device according to some examples of the disclosure.

FIG. 3 illustrates an exemplary electronic device configured to measure tear volume of one or more eyes of the user according to some examples of the disclosure.

FIG. 4 illustrates a zoomed-in view of an eye of a user of an electronic device according to some examples of the disclosure.

FIGS. 5A-5B illustrate an example of angular thresholds of a gaze of one or more eyes of a user according to some examples of the disclosure.

FIG. 6 is a flow diagram illustrating a method for determining a dry-eye condition associated with one or more eyes of a user of an electronic device according to some examples of the disclosure.

FIG. 7 is a flow diagram illustrating a method for determining a tear volume measurement associated with one or more eyes of a user of an electronic device according to some examples of the disclosure.

FIG. 8 is a flow diagram illustrating a method for determining a tear volume measurement associated with one or more eyes of a user of an electronic device according to some examples of the disclosure.

FIG. 9 is a flow diagram illustrating a method for determining a tear volume measurement associated with one or more eyes of a user of an electronic device according to some examples of the disclosure.

FIG. 10 is a flow diagram illustrating a method for performing a baseline tear volume measurement according to some examples of the disclosure.

### DETAILED DESCRIPTION

Described herein are systems and methods for obtaining image data of one or more eyes of a user of an electronic device. The image data of one or more eyes can be used to determine a tear volume measurement. The tear volume measurement can be used, in some examples, to detect a dry-eye condition of the user. In some examples of the disclosure, an electronic device (such as a head-mounted device) includes one more cameras that are positioned to take one or more images of the eyes of the user of the electronic device. In one or more examples, in accordance with a determination that one or more first criteria are satisfied, the electronic device obtains, via the one or more cameras, an image or a plurality of images. The image or the plurality of images includes one or more eyes of a user of the electronic device.

In one or more examples, using the obtained images of the one or more eyes of the user, the electronic device determines a tear volume measurement for images of the one or more eyes of the user of the electronic device. In one or more examples, the electronic device determines a tear meniscus height value of the one or more eyes of the user and uses the determined tear meniscus height value to determine the tear volume measurement. In one or more examples, when the electronic device determines that one or more third criteria are satisfied, including a criterion that is satisfied when the tear volume measurement is below a tear volume threshold, the electronic device determines a dry-eye condition associated with the one or more eyes of the user of the electronic device. In one or more examples, the electronic device notifies the user of a possible dry-eye condition and/or suggests mitigations or follow-up for diagnosis with a health care provider.

In some examples, the electronic device applies one or more processing algorithms/techniques to the obtained images to determine the tear meniscus height value, including but not limited to, one or more image segmentation algorithms and/or one or more image processing algorithms. In one or more examples, the electronic device obtains the one or more images of the eyes in accordance with a determination that the eyes of the user are in a particular state, such as after a blink of the eyes or after (or within) a pre-determined amount of time has passed after a blink of the eyes has occurred. Additionally or alternatively, in one or more examples, the electronic device obtains the images of the eyes in accordance with one or more environmental conditions being satisfied.

In some examples, an electronic device in communication with a display and one or more input devices, in accordance with a determination that one or more first criteria are satisfied, obtains, via the one or more cameras, a plurality of images, wherein the plurality of images includes one or more eyes of a user of the electronic device. Further, in some examples, in accordance with a determination that one or more second criteria are satisfied, the electronic device determines a tear volume measurement for each of the plurality of images of the one or more eyes of the user of the electronic device. Moreover, in some examples, in accordance with a determination that one or more third criteria are satisfied, including a criterion that is satisfied when the tear volume measurement is below a tear volume threshold, the electronic device determines a dry-eye condition associated with the one or more eyes of the user of the electronic device.

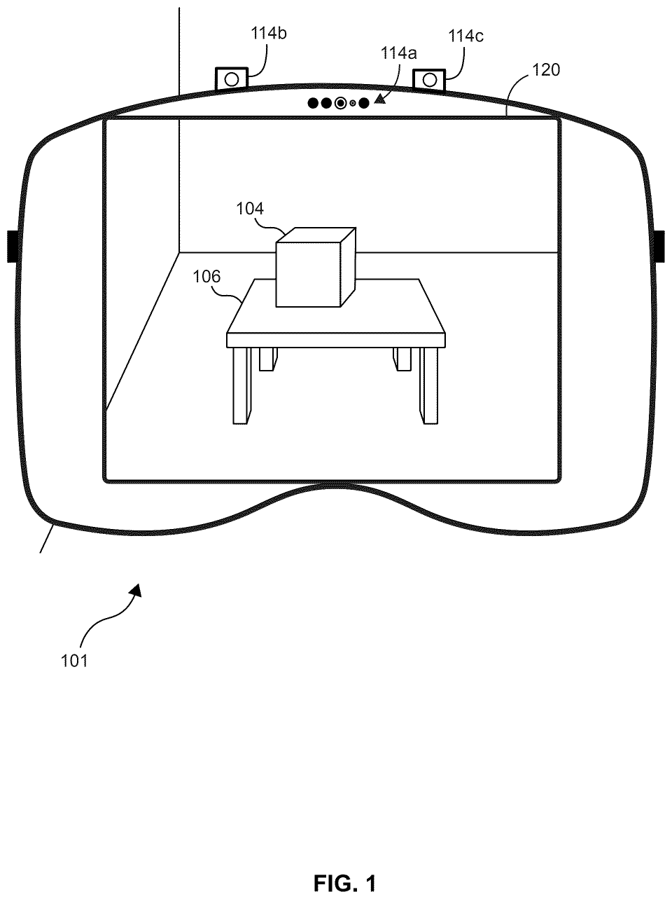

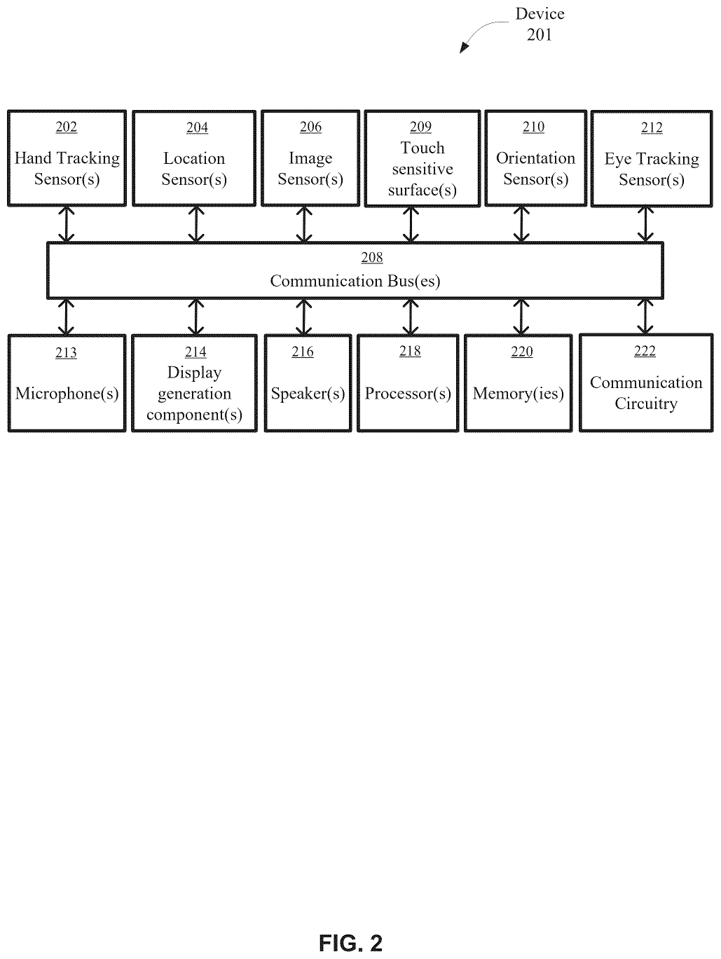

FIG. 1 illustrates an electronic device 101 presenting an extended reality (XR) environment (e.g., a computer-generated environment optionally including representations of physical and/or virtual objects) according to some examples of the disclosure. In some examples, as shown in FIG. 1, electronic device 101 is a head-mounted display or other head-mountable device configured to be worn on a head of a user of the electronic device 101. Examples of electronic device 101 are described below with reference to the architecture block diagrams of FIG. 2. As shown in FIG. 1, electronic device 101 and table 106 are located in a physical environment. The physical environment may include physical features such as a physical surface (e.g., floor, walls) or a physical object (e.g., table, lamp, etc.). In some examples, electronic device 101 may be configured to detect and/or capture images of physical environment including table 106 (illustrated in the field of view of electronic device 101).

In some examples, as shown in FIG. 1, electronic device 101 includes one or more internal image sensors 114a oriented towards a face of the user (e.g., eye tracking cameras described below with reference to FIG. 2). In some examples, internal image sensors 114a are used for eye tracking (e.g., detecting a gaze of the user). Internal image sensors 114a are optionally arranged on the left and right portions of display 120 to enable eye tracking of the user's left and right eyes. In some examples, electronic device 101 also includes external image sensors 114b and 114c facing outwards from the user to detect and/or capture the physical environment of the electronic device 101 and/or movements of the user's hands or other body parts.

In some examples, display 120 has a field of view visible to the user (e.g., that may or may not correspond to a field of view of external image sensors 114b and 114c). Because display 120 is optionally part of a head-mounted device, the field of view of display 120 is optionally the same as or similar to the field of view of the user's eyes. In other examples, the field of view of display 120 may be smaller than the field of view of the user's eyes. In some examples, electronic device 101 may be an optical see-through device in which display 120 is a transparent or translucent display through which portions of the physical environment may be directly viewed. In some examples, display 120 may be included within a transparent lens and may overlap all or only a portion of the transparent lens. In other examples, electronic device may be a video-passthrough device in which display 120 is an opaque display configured to display images of the physical environment captured by external image sensors 114b and 114c. While a single display 120 is shown, it should be appreciated that display 120 may include a stereo pair of displays.

In some examples, in response to a trigger, the electronic device 101 may be configured to display a virtual object 104 in the XR environment represented by a cube illustrated in FIG. 1, which is not present in the physical environment, but is displayed in the XR environment positioned on the top of real-world table 106 (or a representation thereof). Optionally, virtual object 104 can be displayed on the surface of the table 106 in the XR environment displayed via the display 120 of the electronic device 101 in response to detecting the planar surface of table 106 in the physical environment 100.

It should be understood that virtual object 104 is a representative virtual object and one or more different virtual objects (e.g., of various dimensionality such as two-dimensional or other three-dimensional virtual objects) can be included and rendered in a three-dimensional XR environment. For example, the virtual object can represent an application or a user interface displayed in the XR environment. In some examples, the virtual object can represent content corresponding to the application and/or displayed via the user interface in the XR environment. In some examples, the virtual object 104 is optionally configured to be interactive and responsive to user input (e.g., air gestures, such as air pinch gestures, air tap gestures, and/or air touch gestures), such that a user may virtually touch, tap, move, rotate, or otherwise interact with, the virtual object 104.

In some examples, displaying an object in a three-dimensional environment may include interaction with one or more user interface objects in the three-dimensional environment. For example, initiation of display of the object in the three-dimensional environment can include interaction with one or more virtual options/affordances displayed in the three-dimensional environment. In some examples, a user's gaze may be tracked by the electronic device as an input for identifying one or more virtual options/affordances targeted for selection when initiating display of an object in the three-dimensional environment. For example, gaze can be used to identify one or more virtual options/affordances targeted for selection using another selection input. In some examples, a virtual option/affordance may be selected using hand-tracking input detected via an input device in communication with the electronic device. In some examples, objects displayed in the three-dimensional environment may be moved and/or reoriented in the three-dimensional environment in accordance with movement input detected via the input device.

In the discussion that follows, an electronic device that is in communication with a display generation component and one or more input devices is described. It should be understood that the electronic device optionally is in communication with one or more other physical user-interface devices, such as a touch-sensitive surface, a physical keyboard, a mouse, a joystick, a hand tracking device, an eye tracking device, a stylus, etc. Further, as described above, it should be understood that the described electronic device, display and touch-sensitive surface are optionally distributed amongst two or more devices. Therefore, as used in this disclosure, information displayed on the electronic device or by the electronic device is optionally used to describe information outputted by the electronic device for display on a separate display device (touch-sensitive or not). Similarly, as used in this disclosure, input received on the electronic device (e.g., touch input received on a touch-sensitive surface of the electronic device, or touch input received on the surface of a stylus) is optionally used to describe input received on a separate input device, from which the electronic device receives input information.

The device typically supports a variety of applications, such as one or more of the following: a drawing application, a presentation application, a word processing application, a website creation application, a disk authoring application, a spreadsheet application, a gaming application, a telephone application, a video conferencing application, an e-mail application, an instant messaging application, a workout support application, a photo management application, a digital camera application, a digital video camera application, a web browsing application, a digital music player application, a television channel browsing application, and/or a digital video player application.

FIG. 2 illustrates a block diagram of an example architecture for a device 201 according to some examples of the disclosure. In some examples, device 201 includes one or more electronic devices. For example, the electronic device 201 may be a portable device, an auxiliary device in communication with another device, a head-mounted display, etc., respectively. In some examples, electronic device 201 corresponds to electronic device 101 described above with reference to FIG. 1.

As illustrated in FIG. 2, the electronic device 201 optionally includes various sensors, such as one or more hand tracking sensors 202, one or more location sensors 204, one or more image sensors 206 (optionally corresponding to internal image sensors 114a and/or external image sensors 114b and 114c in FIG. 1), one or more touch-sensitive surfaces 209, one or more motion and/or orientation sensors 210, one or more eye tracking sensors 212, one or more microphones 213 or other audio sensors, one or more body tracking sensors (e.g., torso and/or head tracking sensors), one or more display generation components 214, optionally corresponding to display 120 in FIG. 1, one or more speakers 216, one or more processors 218, one or more memories 220, and/or communication circuitry 222. One or more communication buses 208 are optionally used for communication between the above-mentioned components of electronic devices 201.

Communication circuitry 222 optionally includes circuitry for communicating with electronic devices, networks, such as the Internet, intranets, a wired network and/or a wireless network, cellular networks, and wireless local area networks (LANs). Communication circuitry 222 optionally includes circuitry for communicating using near-field communication (NFC) and/or short-range communication, such as Bluetooth®.

Processor(s) 218 include one or more general processors, one or more graphics processors, and/or one or more digital signal processors. In some examples, memory 220 is a non-transitory computer-readable storage medium (e.g., flash memory, random access memory, or other volatile or non-volatile memory or storage) that stores computer-readable instructions configured to be executed by processor(s) 218 to perform the techniques, processes, and/or methods described below. In some examples, memory 220 can include more than one non-transitory computer-readable storage medium. A non-transitory computer-readable storage medium can be any medium (e.g., excluding a signal) that can tangibly contain or store computer-executable instructions for use by or in connection with the instruction execution system, apparatus, or device. In some examples, the storage medium is a transitory computer-readable storage medium. In some examples, the storage medium is a non-transitory computer-readable storage medium. The non-transitory computer-readable storage medium can include, but is not limited to, magnetic, optical, and/or semiconductor storages. Examples of such storage include magnetic disks, optical discs based on compact disc (CD), digital versatile disc (DVD), or Blu-ray technologies, as well as persistent solid-state memory such as flash, solid-state drives, and the like.

In some examples, display generation component(s) 214 include a single display (e.g., a liquid-crystal display (LCD), organic light-emitting diode (OLED), or other types of display). In some examples, display generation component(s) 214 includes multiple displays. In some examples, display generation component(s) 214 can include a display with touch capability (e.g., a touch screen), a projector, a holographic projector, a retinal projector, a transparent or translucent display, etc. In some examples, electronic device 201 includes touch-sensitive surface(s) 209, respectively, for receiving user inputs, such as tap inputs and swipe inputs or other gestures. In some examples, display generation component(s) 214 and touch-sensitive surface(s) 209 form touch-sensitive display(s) (e.g., a touch screen integrated with electronic device 201 or external to electronic device 201 that is in communication with electronic device 201).

Electronic device 201 optionally includes image sensor(s) 206. Image sensors(s) 206 optionally include one or more visible light image sensors, such as charged coupled device (CCD) sensors, and/or complementary metal-oxide-semiconductor (CMOS) sensors operable to obtain images of physical objects from the real-world environment. Image sensor(s) 206 also optionally include one or more infrared (IR) sensors, such as a passive or an active IR sensor, for detecting infrared light from the real-world environment. For example, an active IR sensor includes an IR emitter for emitting infrared light into the real-world environment. Image sensor(s) 206 also optionally include one or more cameras configured to capture movement of physical objects in the real-world environment. Image sensor(s) 206 also optionally include one or more depth sensors configured to detect the distance of physical objects from electronic device 201. In some examples, information from one or more depth sensors can allow the device to identify and differentiate objects in the real-world environment from other objects in the real-world environment. In some examples, one or more depth sensors can allow the device to determine the texture and/or topography of objects in the real-world environment.

In some examples, electronic device 201 uses CCD sensors, event cameras, and depth sensors in combination to detect the physical environment around electronic device 201. In some examples, image sensor(s) 206 include a first image sensor and a second image sensor. The first image sensor and the second image sensor work in tandem and are optionally configured to capture different information of physical objects in the real-world environment. In some examples, the first image sensor is a visible light image sensor and the second image sensor is a depth sensor. In some examples, electronic device 201 uses image sensor(s) 206 to detect the position and orientation of electronic device 201 and/or display generation component(s) 214 in the real-world environment. For example, electronic device 201 uses image sensor(s) 206 to track the position and orientation of display generation component(s) 214 relative to one or more fixed objects in the real-world environment.

In some examples, electronic device 201 includes microphone(s) 213 or other audio sensors. Electronic device 201 optionally uses microphone(s) 213 to detect sound from the user and/or the real-world environment of the user. In some examples, microphone(s) 213 includes an array of microphones (a plurality of microphones) that optionally operate in tandem, such as to identify ambient noise or to locate the source of sound in space of the real-world environment.

Electronic device 201 includes location sensor(s) 204 for detecting a location of electronic device 201 and/or display generation component(s) 214. For example, location sensor(s) 204 can include a global position system (GPS) receiver that receives data from one or more satellites and allows electronic device 201 to determine the device's absolute position in the physical world.

Electronic device 201 includes orientation sensor(s) 210 for detecting orientation and/or movement of electronic device 201 and/or display generation component(s) 214. For example, electronic device 201 uses orientation sensor(s) 210 to track changes in the position and/or orientation of electronic device 201 and/or display generation component(s) 214, such as with respect to physical objects in the real-world environment. Orientation sensor(s) 210 optionally include one or more gyroscopes and/or one or more accelerometers.

Electronic device 201 includes hand tracking sensor(s) 202 and/or eye tracking sensor(s) 212 (and/or other body tracking sensor(s), such as leg, torso and/or head tracking sensor(s)), in some examples. Hand tracking sensor(s) 202 are configured to track the position/location of one or more portions of the user's hands, and/or motions of one or more portions of the user's hands with respect to the extended reality environment, relative to the display generation component(s) 214, and/or relative to another defined coordinate system. Eye tracking sensor(s) 212 are configured to track the position and movement of a user's gaze (eyes, face, or head, more generally) with respect to the real-world or extended reality environment and/or relative to the display generation component(s) 214. In some examples, hand tracking sensor(s) 202 and/or eye tracking sensor(s) 212 are implemented together with the display generation component(s) 214. In some examples, the hand tracking sensor(s) 202 and/or eye tracking sensor(s) 212 are implemented separate from the display generation component(s) 214.

In some examples, the hand tracking sensor(s) 202 (and/or other body tracking sensor(s), such as leg, torso and/or head tracking sensor(s)) can use image sensor(s) 206 (e.g., one or more IR cameras, 3D cameras, depth cameras, etc.) that capture three-dimensional information from the real-world including one or more body parts (e.g., hands, legs, or torso of a human user). In some examples, the hands can be resolved with sufficient resolution to distinguish fingers and their respective positions. In some examples, one or more image sensors 206 are positioned relative to the user to define a field of view of the image sensor(s) 206 and an interaction space in which finger/hand position, orientation and/or movement captured by the image sensors are used as inputs (e.g., to distinguish from a user's resting hand or other hands of other persons in the real-world environment). Tracking the fingers/hands for input (e.g., gestures, touch, tap, etc.) can be advantageous in that it does not require the user to touch, hold or wear any sort of beacon, sensor, or other marker.

In some examples, eye tracking sensor(s) 212 includes at least one eye tracking camera (e.g., infrared (IR) cameras) and/or illumination sources (e.g., IR light sources, such as LEDs) that emit light towards a user's eyes. The eye tracking cameras may be pointed towards a user's eyes to receive reflected IR light from the light sources directly or indirectly from the eyes. In some examples, both eyes are tracked separately by respective eye tracking cameras and illumination sources, and a focus/gaze can be determined from tracking both eyes. In some examples, one eye (e.g., a dominant eye) is tracked by one or more respective eye tracking cameras/illumination sources.

Electronic device 201 is not limited to the components and configuration of FIG. 2, but can include fewer, other, or additional components in multiple configurations. In some examples, electronic device 201 can be implemented between two electronic devices (e.g., as a system). In some such examples, each of (or more) electronic device may each include one or more of the same components discussed above, such as various sensors, one or more display generation components, one or more speakers, one or more processors, one or more memories, and/or communication circuitry. A person or persons using electronic device 201, is optionally referred to herein as a user or users of the device.

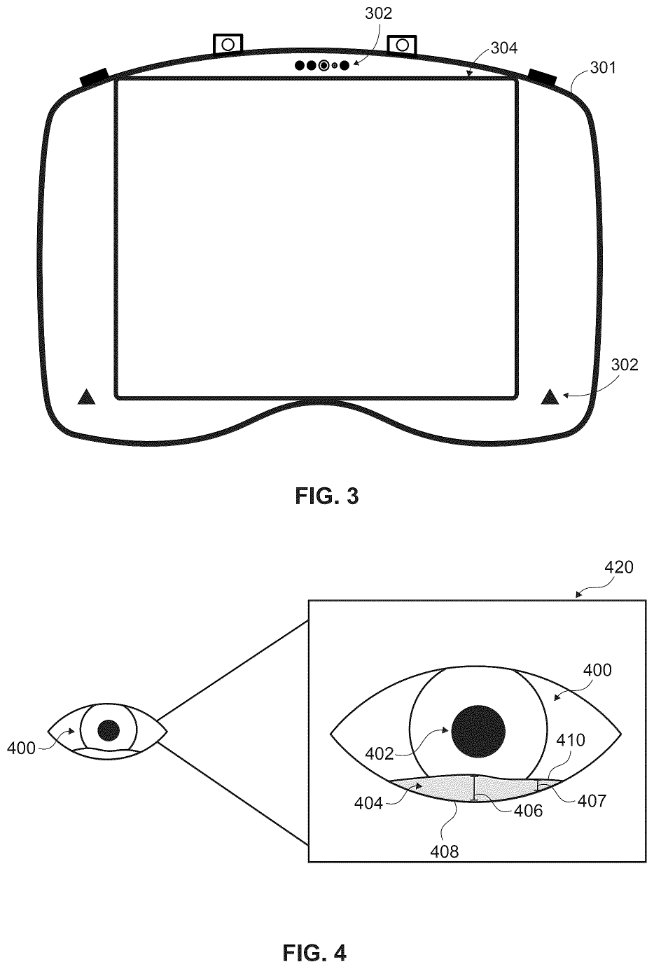

Attention is now directed towards examples for measuring tear volume and/or determining a dry-eye condition associated with one or more eyes of the user of the electronic device using image data obtained from one or more cameras that capture one or more images of the eyes of the user of the electronic device. FIG. 3 illustrates an exemplary computing device configured to determine a tear volume according to examples of the disclosure. It should be noted that electronic device 301 may include any electronic device (e.g., electronic device 201) including the components described above with respect to FIG. 2. As illustrated in FIG. 3, in one or more examples, the electronic device 301 may include one or more cameras 302 and a display 304. The one or more cameras 302 may be similar or the same as the one or more internal image sensors 114, the one or more image sensors 206, the one or more eye tracking sensors 212, or any image sensor described herein. The one or more cameras 302 may be configured to obtain a plurality of images of one or more eyes of the user of the electronic device 301. For example, the one or more cameras 302 may obtain a plurality of images (e.g., a video) and/or static images of the one or more eyes of the user. In some examples, the one or more cameras 302 may include an infrared (IR) camera, a wide-angle camera, a telephoto camera, and/or a visible light camera. For example, the one or more cameras 302 may be implemented as IR cameras to reduce the effect of the visible light on the one or images obtained by the electronic device in order to determine a dry-eye condition. In one or more examples, the one more cameras 302 of electronic device 301 may include IR cameras specifically used to detect a dry-eye condition, and additionally include separate cameras (such as visible light cameras) used for eye-tracking. In some examples, the one or more cameras 302 may be utilized for both eye tracking and to obtain a plurality of images of the one or more eyes of the user.

In some examples, the one or more cameras 302 capture a plurality of images of the one or more eyes of the user in response to the electronic device 301 determining that one or more criteria are satisfied. For example, the one or more criteria can include a criterion that is satisfied when the one or more eyes of the user blinked (e.g., the eye lid of the user has recently closed and then reopened within a pre-determined amount of time). In one or more examples, the one or more cameras 302 may capture a plurality of images of the one or more eyes taken over a period of time and select an image from the plurality of images corresponding to a moment in time that occurred after the user blinked. In some examples, the moment in time that occurred after the user blinked may be determined based on an appearance of one or more respective pupils in the obtained plurality of images. For example, the user's respective eye can be determined to be closed when the respective pupil does not appear in a first image. When the respective pupil is visible in a second image subsequent to the first image, corresponding to the user's eye being open, the electronic device can determine that the user has blinked. The blink determination can be performed for each of the user's eyes independently. Further, the one or more criteria can include a criterion that is satisfied when a predetermined time interval has elapsed after the electronic device 301 determines that the one or more eyes of the user have blinked. For example, the predetermined time interval may be 100 ms, 500 ms, 1 second, 5 seconds, or the like. In some examples, measuring tear volume immediately after or a pre-determined time after a blink has occurred better ensures that the tear volume measurement is consistent across measurements.

In some examples, the display 304 may display a sequence of images that are configured to provoke a blink (or multiple blinks) from the user of the electronic device. For example, electronic device 301 can display virtual content on display 304 that is specifically configured to provoke the user to blink their eyes. In some examples, the sequence of images may include images with varying brightness levels. In some examples, the sequence of images may include content that may cause the one or more eyes of the user to produce tears. For example, the sequence of images on the display may cause the one or more eyes of the user to remain open and naturally “water.” In some examples, the tear fluids accumulate at a lower eye lid (described in further detail with respect to FIG. 4) of the one or more eyes of the user due to gravity. In some examples, each eye of the one or more eyes of the user may include a “film.” For example, the tear film refers to a layer of liquid (e.g., tears) that substantially covers a respective eye. In some examples, the one or more cameras 302 may be positioned on the electronic device 301 such that they can obtain a plurality of images of a lower portion of the one or more eyes of the user (e.g., where the tear volume accumulates).

FIG. 4 illustrates an exemplary image of an eye obtained from the one or more cameras of the electronic device according to one or more examples of the disclosure. As illustrated in FIG. 4, an image of an eye 400 of a user of an electronic device is shown. In one or more examples, the image may be obtained by one or more cameras of the electronic device, as described herein. The image shown in FIG. 4 includes a single eye 400, but it is understood that a second eye could be captured in a second image or multiple eyes of the user can be captured in a single image. In one or more examples, the plurality of images obtained by the one or more cameras of the electronic device may include an area around an eye of the user in addition to the image of the eye itself (e.g., an eyebrow, an eyelash, an eyelid). In some examples, as described in further detail below, the electronic device optionally crops or segments an image to focus on or isolate different portions of the eye for analysis.

In one or more examples, and as illustrated in view 420 (which represents an enlarged and/or enhanced version of image of the single eye 400), the image of eye 400 may include a pupil 402, and a tear volume 404 that has accumulated at the eyelid on the bottom of eye 400 as described above. In some examples, the pupil 402 size varies depending on an amount of light that the pupil was exposed to at the time that image of the eye 400 was obtained. In one or more examples, the tear volume 404, may be distributed differently than shown in FIG. 4. For example, blinking can distribute the tear volume as a film formed over the entirety of the eye, but the tear volume can accumulate at a lower portion of the eye 400 due to gravity. It should be noted that an upper boundary 410 of the tear volume 404 optionally has an irregular shape. For instance, the upper boundary 410 of the accumulated tear volume 404 may have an overall non-linear, curved shape, but may also include some irregularities or inconsistencies in the shape of the curve (e.g., not a smooth curve). In one or more examples, the method of measuring tear volume described herein accounts for inconsistencies in the upper boundary 410 so as to avoid inconsistent measurements by the electronic device when determining the tear volume 404.

In one or more examples, a first tear meniscus height value 406 is determined using the tear volume 404 (e.g., the amount of the accumulated tear volume at the bottom of the eye). In one or more examples, the first tear meniscus height value 406 may be measured from a point on the lower lid 408 of the eye 400 to a point on an upper boundary 410 of the tear volume 404. Thus, in one or more examples, the electronic device determines a boundary of the lower lid 408 of the eye and an upper boundary of the tear volume 404 in order to determine first tear meniscus height value 406. It should be noted that, in some examples, multiple tear meniscus height values may be measured. For example, a first tear meniscus height value 406 may be measured at the center of the eye 400 and a second tear meniscus height value 407 may be measured off-center of the eye 400. In some examples, the maximum tear meniscus height value is determined as the first tear meniscus height value 406. For example, in response to determining that the first tear meniscus height value 406 is larger than the second tear meniscus height value 407, the first tear meniscus height value is used for subsequent analysis. In some examples, the selected tear meniscus height value is based on a minimum, a simple average, a weighted average, a median, a mean, a mode, etc. of the multiple tear meniscus height values. In some examples, the determined first tear meniscus height value 406 may be measured at a fixed location relative the eye 400. In some examples, the fixed location is at the center of the eye. In some examples, the fixed location is offset from the center of the eye from a predetermined amount. In some examples, the fixed location is a predetermined distance from a tear duct (or another eye feature). In some examples, the determined first tear meniscus height value 406 may be measured at dynamic locations relative to the eye 400. For example, the determined first tear meniscus height value 406 at a first time may be measured at a first location (e.g., corresponding to a first maximum height in a first image), whereas the determined first tear meniscus height value 406 at a second time may be measured at a second location (e.g., corresponding to a second maximum height in a second image), different than the first location. That is, depending on the maximum height of the tear volume 404 at a selected time, the first tear meniscus height value 406 may change. In one or more examples, the first tear meniscus height value 406 being measured at dynamic locations may account for any inconsistencies in the upper boundary 410. For example, the first tear meniscus height value 406 at a first time may be measured at a first location, where the first location may be determined to have an inconsistency on the upper boundary 410. In response to determining that the first location corresponds to an inconsistency on the upper boundary 410, the electronic device measures the first tear meniscus height value 406 at a second location, where the second location does not have an inconsistency on the upper boundary 410. It should be noted that any tear meniscus height value described herein may be a single measured tear meniscus height value. Additionally or alternatively, any tear meniscus height value described herein may be an aggregated value compiled from multiple tear meniscus height values measured over a period of time.

Still referring to FIG. 4, the first tear meniscus height value 406 may be used to determine a dry-eye condition associated with the eye 400. For example, symptoms of a dry-eye condition may include a reduction in tear production. As such, a user with reduced tear production may have lower tear volume levels, and correspondingly shorter tear meniscus height values, than expected. In some cases, multiple tear meniscus height values may be aggregated into a single tear meniscus height value. For example, for a single image of the plurality of images of the eye of the user, there may be multiple tear meniscus height values, and the multiple tear meniscus height values may be summed together to yield a cumulative tear meniscus height value. In some examples, a tear meniscus height value location may be determined and respective tear meniscus height values for the determined location may be aggregated for multiple images. For example, a tear meniscus height value location may be determined to be in the center of the eye. The tear meniscus height value at the center of the eye for each image of the plurality of images of the eye may be aggregated into an aggregated tear meniscus height value. It should be noted that the plurality of images obtained of the one or more eyes of the user may be obtained over after predetermined time interval. As such, it may be beneficial to aggregate measurements from the plurality of images to yield a more robust metric that may account for any outliers. For example, an outlier tear meniscus (e.g., a tear meniscus height value measurement that is out of family with other tear meniscus height value measurements) may be attributed to errors in capturing the one or more images, errors in image analysis, or things of the like.

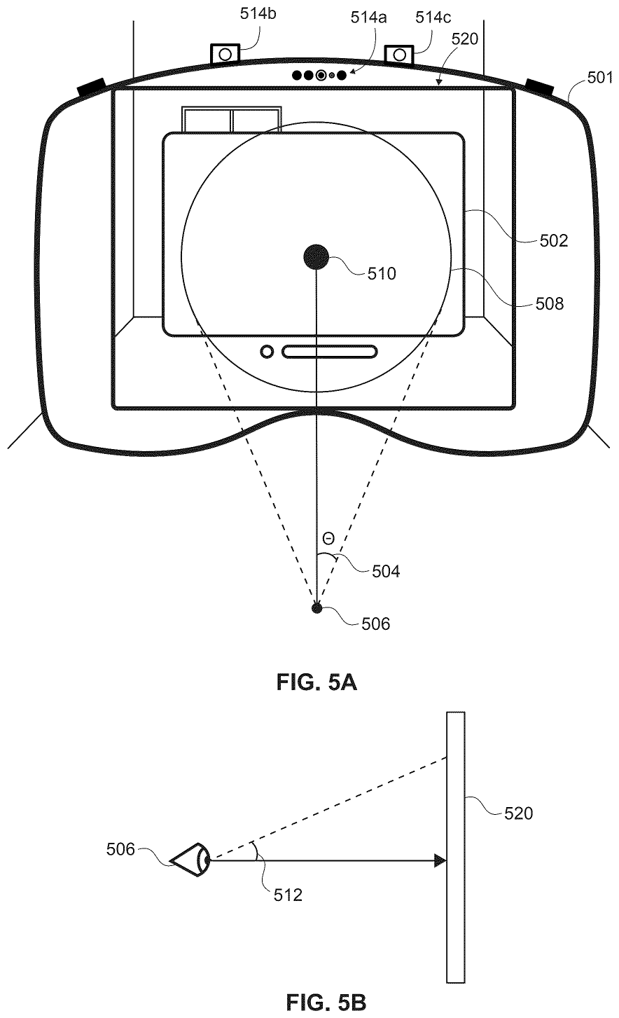

In one or more examples, and as described above, the electronic device can display one or more images that are configured to provoke the user to blink. FIG. 5A illustrates an exemplary display 520 of an electronic device 501 (e.g., electronic device 201, 301) according to one or more examples of the disclosure. In some examples, the electronic device, using display 520, displays virtual window 502. In one or more examples, electronic device 501 displays, at virtual window 502, one or more images that are configured to provoke the user of the electronic device to blink. For example, the one or more images may include a sequence of images or a video. Additionally and/or alternatively, the one or more images may include a series of still images (e.g., a plurality of images) that are collectively configured to provoke a blink from the user of the electronic device 501. Although described above as images displayed within a virtual window 502, it is understood that the images or a subset of pixels of one or more images can be used to trigger blinking with or without displaying the images or subset of pixels of one or more images within a window. In some examples, the one or more images, either displayed in the virtual window 502 or at another location, may have known luminance values that are determined to provoke blinking.

In one or more examples, to ensure that accurate tear volume measurements are made, the electronic device can display the one or more images within a predetermined threshold angular field of view relative to the eye of the user. It should be noted that the tear volume measurements may shift based on a gaze direction. For example, if the gaze direction of one or more eyes of the user is to the right or left, the respective pupils of the one or more eyes may add a darker background to the one or more images captured. As such, it may be difficult to perform image analysis, and subsequently determine an accurate tear volume measurement. For example, as shown in FIG. 5A, virtual window 502 (e.g., where the images are displayed) is displayed within yaw threshold angle 504 of eye 506. In some examples, the virtual window 502 may be positioned on the display 520 to ensure that the one or more eyes are oriented in an optimal direction to determine the tear volume. In one or more examples, the electronic device 501 determines the position of a gaze point of the eye 506 and displays the virtual window 502 such that the at least a portion of the virtual window 502 falls within yaw threshold angle 504. It should be noted that having at least a portion of the virtual window 502 may allow the gaze point of the eye 506 to be focused in a direction that is conducive for tear volume measurements. In one or more examples, the yaw threshold angle 504 is configured such that the field of view of eye 506 falls within (but optionally exceeds) perimeter 508 of eye 506. In one or more examples, the one or more images, with known luminance values, can at partially be displayed outside of perimeter 508. In one or more examples by displaying images within the yaw threshold angle 504, the electronic device 501 can provide a controlled dosage of light that impinges photoreceptors of the one or more eyes thus normalizing the tear volume measurements.

In one or more examples, the perimeter 508, and the angular thresholds are measured relative to the gaze point 510 of the eyes of the user. In one or more examples, the gaze point 510 refers to a point on display 520 that the electronic device 501 determines the eye of the user is focused at. In one or more examples, the electronic device can determine the position of the gaze point 510 and track its movement. For instance, gaze point 510 may move according to a change in the position of focus of eye 506. In one or more examples, the yaw threshold angle 504 as well as the perimeter 508 of the eye can move in accordance with changes in the location of the gaze point 510. For example, if the gaze point 510 moves to the right side of the display 520, then the right side of perimeter 508 may extend past boundaries of the display on the rightmost side of the display 520 due to moving to the right. Accordingly, the left side of the perimeter 508 may move to a more central section of the display 520 due to moving to the right. It should be noted that the example of FIG. 5A is exemplary for one eye of the user of the electronic device. Any tear volume measurement methods disclosed herein may be performed for both eyes of the user of the electronic device. In some examples, perimeter 508 for a first eye, may overlap with a perimeter of a second eye. As such, the one or more images being displayed on the display 520 may be within the yaw angular threshold of the one or more eyes of the user of the electronic device.

Additionally, in order to control the effective dosage of light being administered to the eye, the electronic device can also ensure that any images being displayed are displayed within a pitch angular threshold as illustrated in FIG. 5B (which represents a side view of the interaction between eye 506 and display 520). In some examples, the pitch threshold angle 512 may be the same value as the yaw threshold angle 504. In some examples, the pitch threshold angle 512 may be different than the yaw threshold angle 504. In some examples, the pitch threshold angle 512 may be constrained by the physical parameters of the display 520 For example, relative to the position of the eye 506, the pitch threshold angle 512 may allow for a vertical gaze range that extends past the display 520. As such, in some examples, the yaw threshold angle 504 may have more significance in outlining the perimeter 508, signifying which portion of the display 520 that the one or more images being displayed can yield accurate tear volume measurements. It should be noted that the orientation of electronic device 501 on the head of the user may influence the yaw threshold angle 504 and the pitch threshold angle 512. To correct this, and in response to detecting that the orientation of the electronic device 501 is not conducive to tracking eye movements, the electronic device 501 may display a notification on the display 520 to instruct the user of the electronic device 501 to adjust the electronic device 501 on the head of the user, to ensure accurate eye tracking by the one or more cameras 514. In some examples, the movement of the electronic device 501 may cause the threshold angles (e.g., yaw threshold angle 504 and pitch threshold angle 512) to be inaccurate (e.g., the eyes of the user may be misaligned with the orientation of the electronic device). Movement of the electronic device 501 may be caused by the user of the electronic device. For example, the user may be walking, jogging, running, or the like, and that may cause the electronic device 501 to move from a stationary position. As such, the threshold angles (e.g., yaw threshold angle 504 and pitch threshold angle 512) may require a correction. In some examples, the electronic device can apply one or more corrections to the threshold angles. In some examples, the electronic device may apply a scaling factor correction to the threshold angles. The scaling factor correction may be determined by an amount of misalignment with the orientation of the electronic device. For example, it may be determined that the orientation of the electronic device is misaligned by 10 percent. Accordingly, the scaling factor may be set to 10 percent and applied to the threshold angles. It should be noted that the threshold angles are measured relative to the eye 506.

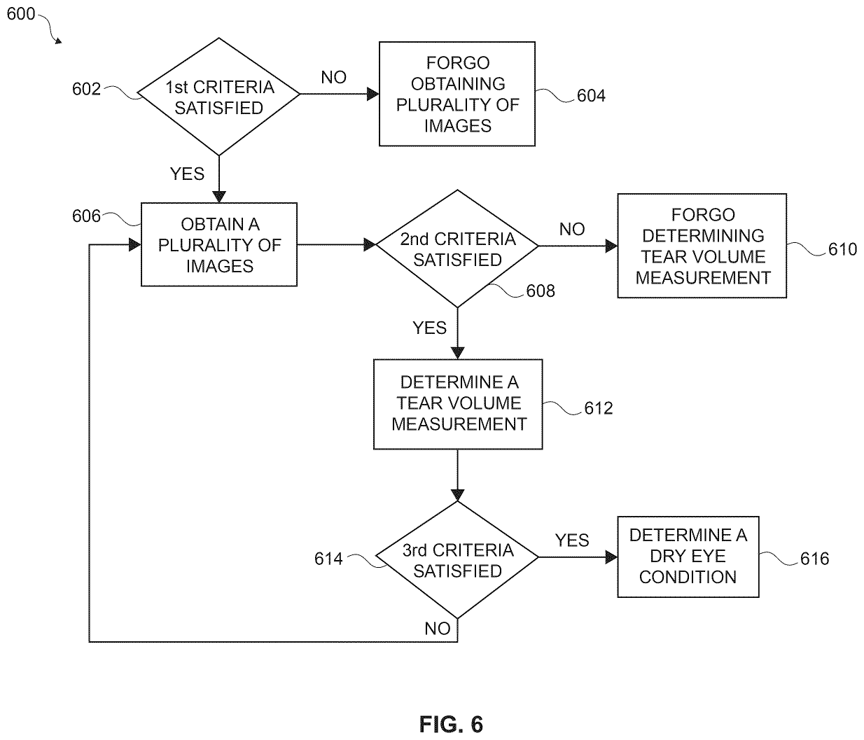

FIG. 6 is a flow diagram illustrating a method 600 for determining a dry-eye condition associated with one or more eyes of a user of an electronic device. In some examples, an electronic device (e.g., 201, 301, 501) performs method 600 as described herein. In some examples, one or more hardware modules/processors (for instance the hardware modules/processors described above with respect to FIG. 2) performs method 600 as described herein. Optionally, one or more operations of the method 600 are programmed in instructions stored using non-transitory computer readable storage media.

At 602, the electronic device may determine whether one or more first criteria associated with the one or more eyes of the user of the electronic device are satisfied. The one or more first criteria, as an example, may include a determination regarding the power state of the device. For example, the one or more first criteria optionally include a criterion that is satisfied when a power state of the device is above a predetermined threshold (e.g., the battery charge left on the device is above a pre-determined threshold and/or the device is connected to a power source). The power state of the device may limit the functionality of one or more components of the device. In some examples, limiting the one or more components may reduce the power draw of the one or more components thus making any tear volume measurements inaccurate. For example, a display of the device may have an upper limit for the brightness of the display when the power state of the device is below a predetermined threshold. In some examples, when the power state is below a predetermined threshold, one or more cameras of the device may not capture a plurality of images of the one or more eyes of the user with the same frequency, relative to the frequency when the power state is above a predetermined threshold. In some examples, when the power state of the device is below a predetermined threshold, the fidelity of the one or more images captured by one or more cameras may be less than the fidelity of one more images captured when the power state is above the predetermined threshold. In one or more examples, the one or more first criteria optionally include a criterion that is satisfied when it is determined that one or more eyes of the user of the device has blinked, as described above in FIG. 3. In some examples, the criterion of the one or more first criteria is satisfied when the one or more environmental conditions are below a predetermined threshold. For example, the one or more first criteria include a criterion that is satisfied when the temperature of the electronic device is below a pre-determined threshold. In one or more examples, one or more environmental conditions may limit the capturing of the plurality of images by the device. For example, when the ambient temperature of the electronic device is above a pre-determined threshold, it may cause the electronic device to overheat. In some examples, the pre-determined temperature threshold may be 90 degrees Fahrenheit, 95 degrees Fahrenheit, 100 degrees Fahrenheit of the like. Accordingly, certain capabilities of the electronic device may be limited until the electronic device cools down. In some examples, the capturing the plurality of images may be opportunistic; meaning that it is a passive measurement (e.g., no initiation by the user) that may occur in the background while the user wears the electronic device. Further, the one or more environmental conditions may also cause the one or more eyes of the user to produce more tears than normal. For example, if the ambient temperature of the electronic device is above a pre-determined threshold, the one or more eyes of the user may produce more tear volume than when the ambient temperature of the electronic device is below the pre-determined threshold. As such, the ambient temperature of the electronic device may affect the tears produced by one or more eyes of the user and the electronic device measuring the tears produced; potentially yielding inaccurate tear volume measurements that may lead to false determinations of a dry-eye condition. When the one or more first criteria are not satisfied, the electronic device, at 604, optionally forgoes obtaining an image or a plurality of images of the one or more eyes of the user. When the one or more first criteria are satisfied, the electronic device, at 606, obtains an image or a plurality of images of the one or more eyes of the user, as described herein.

At 608, the electronic device may determine whether one or more second criteria associated with the one or more eyes of the user of the electronic device are satisfied. The one or more second criteria may determine whether one or more images captured by one or more cameras of the device are sufficient for tear volume measurement. In some examples, a criterion of the one or more second criteria may be satisfied when the one or more captured images have a clarity value above a predetermined threshold. The clarity value predetermined threshold may be set based on the clarity value needed to distinguish between the tear film of one or more eyes of the user and the tear volume of the one or more eyes of the user, within one or more images. The clarity value predetermined threshold may be set based on image contrast values that maximize the visibility of the tear volume of one or more eyes of the user. For example, the clarity value predetermined threshold may be extracted from previous images of the one or more eyes of the user that yielded precise tear volume measurements. In one or more examples, the contrast values for the middle tones of the previous images of the one or more eyes of the user that yielded precise tear volume measurements may be used to determine the clarity value predetermined threshold. In some examples, a criterion of the one or more second criteria may be satisfied when the one or more captured images have a resolution value above a predetermined threshold. The resolution predetermined threshold may be set based on the resolution needed to identify the tear volume in one or more eyes of the user. In another example, the ambient light may be above a pre-determined threshold and an environment passthrough level may be high, allowing a significant amount of environmental light into the one or more eyes of the user. The environment passthrough level indicates how much of the physical environment is presented to the user of the electronic device. In some examples, when the eyes of the user are exposed to environmental light that is above a threshold amount, the eyes may produce a higher than normal amount of tear volume. The ambient light level, the environment passthrough level, or both, may not satisfy the one or more second criteria and cause the device to forgo determining a tear volume measurement. When the one or more second criteria are not satisfied, the device, at 610, optionally forgoes determining a tear volume measurement. When the one or more second criteria are satisfied, the electronic device, at 612, may determine a tear volume measurement corresponding to the one or more eyes of the user of the device.

In some examples, as part of the tear volume measurement process at 612, one or more of the plurality of images of the one or more eyes of the user may be obtained. In some examples, the one or more of the plurality of images is obtained in a first format. In some examples, the one or more of the plurality of images are analyzed to extract one or more measurements from one or more of the plurality of images. In some examples, the one or more measurements are converted from a first format to a second, different format. As an example, the one or more measurements may be initially made in a pixel format, and then converted to other formats, such as metric or standard units using a predetermined conversion factor. The predetermined conversion factor may be a pixel per inch (PPI) conversion that converts pixels to inches. Once the pixels are converted to inches, or any suitable format/units, a tear meniscus height value may be measured, as described in further detail below.

In some examples, determining a tear volume measurement at 612 includes analyzing one or more of the plurality of images using one or more image analysis techniques. The image analysis techniques may include, but are not limited to, inverting images, background subtraction, filtering, cropping, and/or image enhancements. In some examples, the one or more image analysis methods may segment one or more of the plurality of images such that the electronic device may process segments of interest. For example, a segment of interest of one or more of the plurality of images may focus on the lower eyelid of the one or more eyes of the user (e.g., the location of the tear volume). Advantageously, the segment of interest may reduce the computational processing burden of the electronic device because only the segment of interest may be processed by the electronic device thereby reducing the processing burden and/or complexity.

In some examples, as part of determining the tear volume measurement, a machine learning model may be utilized to segment the plurality of images. In some examples, the machine learning model may be trained to receive inputs or one or more images of the eyes of the user, and output one or more tear volume measurements corresponding to respective images of the one or more images. In some examples, the machine learning model may be trained to receive inputs of one or more images to output one or more image segments corresponding to the one or more images that are input into the machine learning model. For example, a machine learning model may be trained using training data that correlates historical images of one or more eyes to historical image segments. The historical images of one or more eyes may include images of the one or more eyes previously obtained by the electronic device, and the historical image segments include image segments associated with the historical images. For example, the historical images may be images obtained previously while the historical image segments may be one or more respective image segments associated with the historical images. In some examples, historical image segments include a segment of interest of one or more of the historical images that focus on the lower eyelid of the one or more eyes of the user (e.g., the location of the tear meniscus). Advantageously, the segment of interest may reduce the computational processing burden of the electronic device because only the segment of interest may be processed by the electronic device thereby reducing the processing burden and/or complexity. In some examples, the training data may include data from the user of the electronic device. In some examples, the training data may include data from users of other electronic devices. In some examples, the machine learning model may include one or more constraints. For example, the one or more constraints may include, but are not limited to, image size, a count of one of or more images, resolutions of one or more of the plurality of images, or the like. In some examples, the machine learning model may be iterative. For example, the training data may be input into an iterative algorithm that has one or more parameters that are optimized through multiple iterations (e.g., different inputs). In some examples, the one or more parameters may be associated with the one or more constraints of the machine learning model, mentioned above. In some examples, the machine learning model may operate on machine learning hardware configured to run the machine learning model. For example, the machine learning model may be initialized by one or more processors configured to receive inputs and to output one or more outputs as described herein. In some examples, the one or more processors may include firmware and/or software that is configured to operate the machine learning model. It should be noted that the firmware and/or software may be updated in response to more training data becoming available to refine the precision and/or accuracy of the machine learning model.

Further, in some examples, and as part of determining the tear volume measurement at 612, the electronic device may optionally determine a location of a tear meniscus. The tear meniscus may be a curvature of the tear volume located on the lower eyelid of the one or more eyes of the user. In some cases, the tear meniscus may be centrally located within the tear volume. In some examples, the tear meniscus may be utilized to determine a tear meniscus height value. It should be noted that the tear meniscus height value is directly correlated to tear volume. For example, a relatively tall tear meniscus height value corresponds to a large tear volume measurement, whereas a relatively short tear meniscus height value corresponds to a small tear volume measurement. In some examples, the above-mentioned machine learning model or another machine learning model is used to determine the tear meniscus height value. In some examples, the machine learning model may be trained to receive inputs of one or more images and output one or more tear meniscus locations corresponding to respective images of the one more input images. For example, a machine learning model may be trained using training data that correlates historical images of one or more eyes to historical tear meniscus height values. In some examples, the historical images of one or more eyes may include images of the one or more eyes previously obtained by the electronic device. In some examples, the training data may include historical image segments correlated to historical tear meniscus height values. It should be noted that the training data including the historical image segments may be a subset of the training data including the historical images of one or more eyes of the user. In some examples, the training data may include data from the user of the electronic device. In some examples, the training data may include de-identified data from users of other electronic devices. In some examples, the machine learning model may include one or more constraints. For example, the one or more constraints may include, but are not limited to, image size, pixel counts, resolutions of one or more of the plurality of images, or the like. In some examples, the machine learning model may be iterative. For example, the training data may be input into an iterative algorithm that has one or more parameters that are optimized through multiple iterations (e.g., different inputs). In some examples, the one or more parameters may be associated with the one or more constraints of the machine learning model, mentioned above.

In some examples, as part of determining the tear volume at 612, the electronic device may optionally adjust a determined tear volume based on the environmental conditions. In some examples, the environmental conditions may include, but are not limited to, ambient light surrounding the electronic device, temperature, humidity, optical inserts, and/or the like. Ambient light surrounding the electronic device may affect how a sequence of images are displayed on the display and may also affect the amount of tear volume of the one or more eyes of the user. For example, bright ambient light (e.g., light above a predetermined threshold) may cause the display to display a sequence of images at a higher brightness, and thus more tear volume may be produced. In some cases, a dim ambient light may cause the display to display a sequence of images at a lower brightness, and thus less tear volume may be produced. Further, optical inserts for the electronic device may reduce or increase the amount of tear volume produced. For example, the optical inserts may be one or more frames that are mounted on the electronic device. In some examples, the optical inserts may assist the user of the electronic device in viewing a display of the electronic device (e.g., prescription lenses, polarized lenses). As such, the optical inserts may reduce the strain of the one or more eyes while viewing content on the display. In some examples, the optical inserts may reduce an amount of light that enters the one or more eyes of the user from the environment and/or the display. As such, less tear volume may be produced as less light is allowed into the one or more eyes of the user. Depending on the magnitude of effect that some environmental conditions may have of the production of tear volume, a correction algorithm may be utilized to adjust the tear volume measurements, the sequence of image being display on the display, or any combination thereof. In some examples, environmental conditions may not only affect the production of tear volume from the one or more eyes of the user, but also the operation of the electronic device itself.

At 614, the electronic device may determine whether one or more third criteria associated with the one or more eyes of the user of the electronic device are satisfied. The one or more third criteria may include a criterion that is satisfied when a tear volume measurement is below a predetermined threshold. The tear volume measurement being below the predetermined threshold may indicate, for example, that the one or more eyes of the user of the electronic device may be failing to produce tears, the eyes have dried out due to overuse of the electronic device, the eyes are producing less tears than expected, and/or the eyes are drier than expected. In some examples, a criterion of the one or more third criteria is satisfied when tear volume measurement is consistently below a predetermined threshold. For example, the tear volume measurement may be below the predetermined threshold for a number of consecutive measurements (e.g., 5 measurements, 10 measurements, 15 measurements). In some examples, the tear volume measurement may be below the predetermined threshold over a period of time (e.g., 5 mins, 10 mins, 15 mins). In some examples, when the one or more third criteria are satisfied, the electronic device determines a dry-eye condition at 616. In some examples, in accordance with determining the one or more third criteria are satisfied, the electronic device may repeat method 600 (or a subset thereof, such as starting at 606) one or more times to ensure that the determination of the dry-eye condition at 616 is not in error. When the one or more third criteria are not satisfied, the electronic device may forgo determining the dry-eye condition, and optionally repeats method 600 (or a subset thereof, such as starting at 606). In some examples, the method 600 may be repeated at periodic time intervals (e.g., 5 mins, 10 mins, 1 hour). In some examples, the method 600 may be repeated based on a trigger event (alternatively or additionally to performing the method periodically). For example, the trigger event may be a drastic change in conditions (e.g., a sudden increase in ambient light), an increase and/or decrease in blinking of the one or more eyes of the user, an increase in brightness of the display of the device, or the like. In some examples, the frequency of the device performing method 600 may increase after a tear volume measurement is determined to be below the predetermined threshold. For example, the device may determine a tear volume measurement every 10 minutes initially but increase the frequency to every 5 minutes upon determining that the determined tear volume measurement is below the predetermined threshold. Additionally, or alternatively, the frequency in which method 600 is performed may be decreased if the determined tear volume measurement is above the predetermined threshold. For example, the device may determine a tear volume measurement every 10 minutes initially but decrease the frequency to every 15 minutes upon determining that the determined tear volume measurement is above the predetermined threshold.

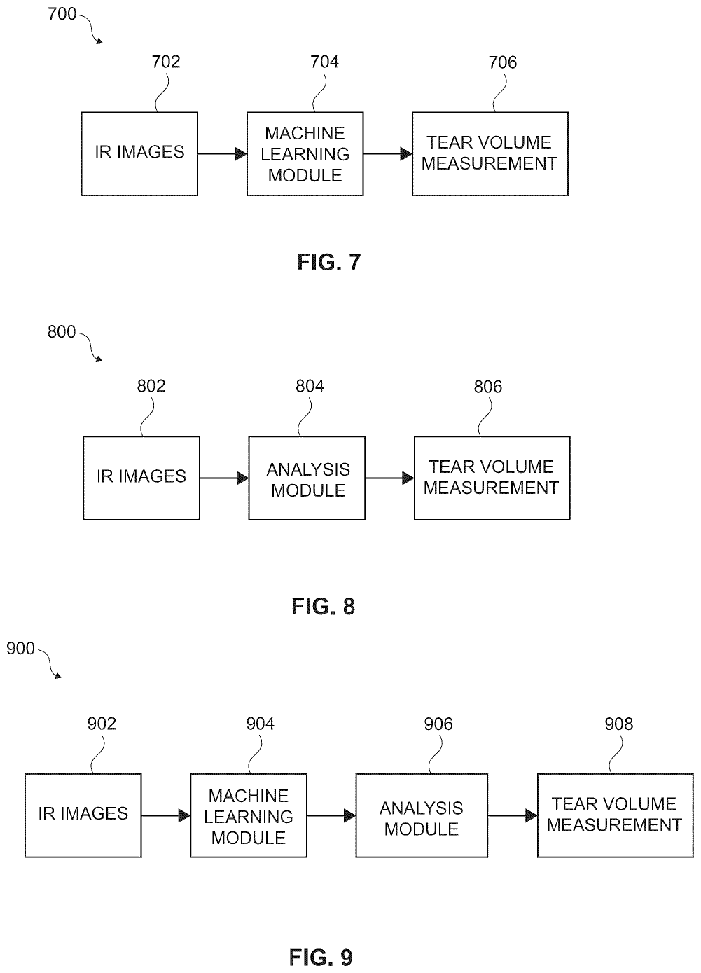

FIG. 7 is a flow diagram illustrating a method 700 for determining a tear volume measurement associated with one or more eyes of a user of an electronic device. In one or more examples, the method 700 corresponds to operation at 612 of the method 600 described above with respect to FIG. 6. In some examples, an electronic device (e.g., 201, 301, 501) performs method 700 as described herein. In some examples, one or more hardware modules/processors performs method 700 as described herein. Optionally, one or more operations of the method 700 are programmed in instructions stored using non-transitory computer readable storage media.

At 702, the electronic device may obtain a plurality of infrared (IR) images from the one or more cameras of the electronic device (described above). In some examples, the obtained plurality of IR images may be input into a machine learning module at 704. The machine learning module may be used to process the plurality of IR images, as described herein. In some examples, the machine learning module may be used to determine tear volume measurements, at 706, based at least on the plurality of IR images. In some examples, the machine learning module includes a machine learning model. In some examples, the machine learning model may be trained to receive inputs of a plurality of IR images and output one or more tear volume measurements corresponding to respective images of the plurality of IR images. In some examples, the machine learning model may be trained to receive inputs of a plurality of IR images to output one or more image segments correspond to the plurality of IR images that are input into the machine learning model. It should be noted that the machine learning model may include supervised machine learning models, unsupervised machine models, or other suitable machine learning models. In some examples, a machine learning model may be utilized to segment the plurality of IR images. For example, a machine learning model may be trained using training data that correlates historical images of one or more eyes to historical image segments. In some examples, the training data may include data from the user of the electronic device. In some examples, the training data may include data from users of other electronic devices. In some examples, the machine learning model may include one or more constraints. For example, the one or more constraints may include, but are not limited to, image size, a count of one of or more images, resolutions of one or more of the plurality of IR images, or the like. In some examples, the machine learning model may be iterative. For example, the training data may be input into an iterative algorithm that has one or more parameters that are optimized through multiple iterations (e.g., different inputs). In some examples, the one or more parameters may be associated with the one or more constraints of the machine learning model, mentioned above.

FIG. 8 is a flow diagram illustrating a method 800 for determining a tear volume measurement associated with one or more eyes of a user of an electronic device. In some examples, an electronic device (e.g., 201, 301, 501) performs method 800 as described herein. In some examples, one or more hardware modules/processors performs method 800 as described herein. Optionally, one or more operations of the method 800 are programmed in instructions stored using non-transitory computer readable storage media.

At 802, the electronic device may obtain a plurality of infrared (IR) images. In some examples, the plurality of IR images may be obtained using one or more cameras of the electronic device. The obtained plurality of IR images may have one or more analysis processes applied at 804. The analysis processes may be used to process the plurality of IR images, as described herein. In some examples, the analysis processes may be performed by one or more processors that have firmware and/or software configured to perform image analysis, as described herein. In some examples, one or more of the plurality of IR images may be analyzed using one or more image analysis methods. The image analysis methods may include, but are not limited to, inverting images, background subtraction, image enhancements, or things of the like. In some examples, the one or more image analysis method may segment one or more of the plurality of IR images such that the electronic device may process segments of interest. For example, a segment of interest of one or more of the plurality of IR images may focus on the lower eyelid of the one or more eyes of the user. In some examples, the analysis module may be used to determine tear volume measurements, at 806, based at least on the plurality of IR images.

FIG. 9 is a flow diagram illustrating a method 900 for determining a tear volume measurement associated with one or more eyes of a user of an electronic device. In some examples, an electronic device (e.g., 201, 301, 501) performs method 900 as described herein. In some examples, one or more hardware modules/processors performs method 800 as described herein. Optionally, one or more operations of the method 900 are programmed in instructions stored using non-transitory computer readable storage media.

At 902, the electronic device may obtain a plurality of infrared (IR) images. In some examples, the plurality of IR images may be obtained using one or more cameras of the electronic device. The plurality of IR images may be input into a machine learning module, at 904. Further, the obtained plurality of IR images may be input to the one or more analysis processes at 906 from the machine learning module at 904. The analysis processes may be used to process the plurality of IR images, as described herein. It should be noted that operations at 904 and at 906 may be in any order. In some examples, the plurality of IR images may be input into the machine learning module to identify one or more features of an eye of the user (e.g., pupil, iris, eye lid). The machine learning module at 904 may also be segment one or more of the plurality of IR images based at least on the identified features. Further, the processed IR images be input the one or more analysis processes at 906 to measure the tear volume measurement at 908. For example, the processed IR images may include a segment of one or more of the plurality of IR images, where the segment is a lower half of the eye of the user of the electronic device.

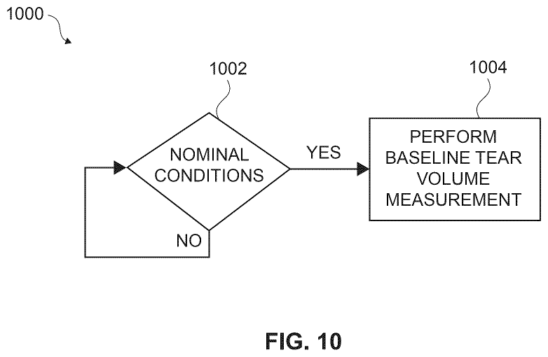

FIG. 10 is a flow diagram illustrating a method 1000 for performing a baseline tear volume measurement. In some examples, an electronic device (e.g., 201, 301, 501) performs method 1000 as described herein. In some examples, one or more hardware modules/processors performs method 800 as described herein. Optionally, one or more operations of the method 1000 are programmed in instructions stored using non-transitory computer readable storage media.

At 1002, the electronic device may determine whether one or more nominal conditions associated with the one or more eyes of the user of the electronic device are satisfied. In some examples, as described in FIG. 6, the one or more criteria, the one or more second criteria, and the one or more third criteria need to be satisfied to determine the tear volume measurement. However, determining a baseline measurement (e.g., a measurement to compare other measurements to, to determine any abnormalities in tear volume) may require more specific conditions. The baseline measurement may be determined when more than one of the one or more first criteria and more than one of the one or more second criteria are concurrently satisfied. For example, the baseline measurement may be determined when the predetermined amount of time has elapsed since a user of the device has blinked, the temperature of the device is below a predetermined threshold, a clarity value of one or more images exceeds a predetermined threshold, and a resolution value of one or more images exceeds a predetermined threshold. In some examples, one or more images of the one or more eyes of the user, used to determine baseline measurements of the one or more eyes of the user may be obtained the one or more cameras. In some examples, the baseline measurements may be taken from a single image of the one or more eyes of the user, obtained by the one or more cameras. In some examples, the baseline measurements may be taken from a plurality of images obtained by the one or more cameras. Subsequent tear volume measurements may be compared to the baseline measurements to determine a dry-eye condition associated with the one or more eyes of the user. If the one or more nominal conditions are not satisfied, the electronic device may repeat step 1002 until the one or more nominal conditions are satisfied. If the one or more nominal conditions are satisfied, the electronic device, at 1004, may perform a baseline tear volume measurement, as described herein. For example, one or more cameras of the electronic device may obtain a plurality of images of one or more eyes of the user and perform image analysis to determine a baseline tear volume measurement.

Therefore, according to the above, some examples of the disclosure are directed to a method comprising, at an electronic device in communication with one or more displays and one or more input devices including one or more cameras: in accordance with a determination that one or more first criteria are satisfied, obtaining, via the one or more cameras, a plurality of images, wherein the plurality of images includes one or more eyes of a user of the electronic device; in accordance with a determination that one or more second criteria are satisfied, determining a tear volume measurement for one or more of the plurality of images of the one or more eyes of the user of the electronic device; and in accordance with a determination that one or more third criteria are satisfied, including a criterion that is satisfied when the tear volume measurement is below a tear volume threshold, determining a dry-eye condition associated with the one or more eyes of the user of the electronic device.

Additionally or alternatively, in some examples, determining the tear volume measurement includes determining a tear meniscus height value from the plurality of images. Additionally or alternatively, in some examples, determining the tear volume measurement from the plurality of images includes applying a machine learning model to the one or more of the plurality of images to determine a location of a tear volume in the one or more of the plurality of images. Additionally or alternatively, in some examples, the one or more cameras includes an infrared (IR) camera. Additionally or alternatively, in some examples, determining the tear volume measurement includes: applying one or more image processing algorithms to the one or more of the plurality of images. Additionally or alternatively, in some examples, determining the tear volume measurement includes: determining the tear volume measurement in pixels based on the plurality of images; and converting the determined tear volume measurement from pixels to a distance measurement using a predetermined pixel per inch (PPI) factor.

Additionally or alternatively, in some examples, the one or more first criteria include a criterion that is satisfied in accordance with a determination that the one or more eyes of the user have blinked, and a criterion that is satisfied in accordance with a determination that a predetermined time interval has passed after the one or more eyes of the user have blinked. Additionally or alternatively, in some examples, determining the tear volume measurement further comprises: determining a gaze direction of the one or more eyes of the user; and applying a correction algorithm to the plurality of images based on the determined gaze direction of the one or more eyes. Additionally or alternatively, in some examples, the one or more first criteria are satisfied when a gaze direction of the one or more eyes of the user of the electronic device is within a predetermined angular threshold. Additionally or alternatively, in some examples, the method further comprises determining an aggregate tear volume measurement for the plurality of images of the one or more eyes of the user of the electronic device; and wherein the one or more third criteria include a criterion that is satisfied when the aggregate tear volume measurement is below the tear volume threshold. Additionally or alternatively, in some examples, determining the tear volume measurement includes applying an environmental correction algorithm to the plurality of images. Additionally or alternatively, in some examples, the one or more first criteria are satisfied in accordance with a determination that one or more environmental conditions are satisfied.

Additionally or alternatively, in some examples, determining a dry-eye condition comprises: comparing the determined tear volume measurement with a baseline tear volume measurement, wherein the baseline tear volume measurement is generated according to a process comprising: in accordance with a determination that one or more environmental criteria are satisfied: obtaining, via the one or more cameras, a baseline image of the one or more eyes of the user; and determining a tear volume measurement from the baseline image of the one or more eyes of the user of the electronic device. Additionally or alternatively, in some examples, the one or more first criteria include a criterion that is satisfied in accordance with a determination that a power state of the electronic device is a first power state.

Some examples of the disclosure are directed to an electronic device, comprising one or more processors, memory, and means for performing any of the above methods.

Some examples of the disclosure are directed to a computer readable storage medium storing one or more programs, the one or more programs comprising instructions, which when executed by one or more processors of an electronic device, cause the electronic device to perform any of the above methods.

The present disclosure contemplates that in some examples, the data utilized may include personal information data that uniquely identifies or can be used to contact or locate a specific person. Such personal information data can include demographic data, content consumption activity, location-based data, telephone numbers, email addresses, twitter ID's, home addresses, data or records relating to a user's health or level of fitness (e.g., vital signs measurements, medication information, exercise information), date of birth, or any other identifying or personal information. Specifically, as described herein, one aspect of the present disclosure is tracking a user's biometric data.

The present disclosure recognizes that the use of such personal information data, in the present technology, can be used to the benefit of users. For example, personal information data may be used to display suggested text that changes based on changes in a user's biometric data. For example, the suggested text is updated based on changes to the user's age, height, weight, and/or health history.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users and should be updated as the collection and/or use of data changes. Personal information from users should be collected for legitimate and reasonable uses of the entity and not shared or sold outside of those legitimate uses. Further, such collection/sharing should occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the US, collection of or access to certain health data may be governed by federal and/or state laws, such as the Health Insurance Portability and Accountability Act (HIPAA); whereas health data in other countries may be subject to other regulations and policies and should be handled accordingly. Hence different privacy practices should be maintained for different personal data types in each country.

Despite the foregoing, the present disclosure also contemplates examples in which users selectively block the use of, or access to, personal information data. That is, the present disclosure contemplates that hardware and/or software elements can be provided to prevent or block access to such personal information data. For example, the present technology can be configured to allow users to select to “opt in” or “opt out” of participation in the collection of personal information data during registration for services or anytime thereafter. In another example, users can select not to enable recording of personal information data in a specific application (e.g., first application and/or second application). In addition to providing “opt in” and “opt out” options, the present disclosure contemplates providing notifications relating to the access or use of personal information. For instance, a user may be notified upon initiating collection that their personal information data will be accessed and then reminded again just before personal information data is accessed by the device(s).

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing specific identifiers (e.g., date of birth, etc.), controlling the amount or specificity of data stored (e.g., collecting location data a city level rather than at an address level), controlling how data is stored (e.g., aggregating data across users), and/or other methods.

The foregoing description, for purpose of explanation, has been described with reference to specific examples. However, the illustrative discussions above are not intended to be exhaustive or to limit the disclosure to the precise forms disclosed. Many modifications and variations are possible in view of the above teachings. The examples were chosen and described in order to best explain the principles of the disclosure and its practical applications, to thereby enable others skilled in the art to best use the disclosure and various described examples with various modifications as are suited to the particular use contemplated.

What is claimed is:

1. An electronic device in communication with one or more displays and one or more input devices including one or more cameras, the electronic device comprising:
one or more processors;
memory; and
one or more programs, wherein the one or more programs are stored in the memory and configured to be executed by the one or more processors, the one or more programs including instructions for:
in accordance with a determination that one or more first criteria are satisfied, obtaining, via the one or more cameras, a plurality of images, wherein the plurality of images includes one or more eyes of a user of the electronic device;
in accordance with a determination that one or more second criteria are satisfied, determining a tear volume measurement for one or more of the plurality of images of the one or more eyes of the user of the electronic device; and
in accordance with a determination that one or more third criteria are satisfied, including a criterion that is satisfied when the tear volume measurement is below a tear volume threshold, determining a dry-eye condition associated with the one or more eyes of the user of the electronic device.

2. The electronic device of claim 1, wherein determining the tear volume measurement includes determining a tear meniscus height value from the plurality of images.

3. The electronic device of claim 1, wherein determining the tear volume measurement from the plurality of images includes applying a machine learning model to the one or more of the plurality of images to determine a location of a tear volume in the one or more of the plurality of images.

4. The electronic device of claim 1, wherein determining the tear volume measurement includes:
applying one or more image processing algorithms to the one or more of the plurality of images.

5. The electronic device of claim 4, wherein determining the tear volume measurement includes:
determining the tear volume measurement in pixels based on the plurality of images; and
converting the determined tear volume measurement from pixels to a distance measurement using a predetermined pixel per inch (PPI) factor.

6. The electronic device of claim 1, wherein the one or more first criteria include a criterion that is satisfied in accordance with a determination that the one or more eyes of the user have blinked, and a criterion that is satisfied in accordance with a determination that a predetermined time interval has passed after the one or more eyes of the user have blinked.

7. The electronic device of claim 1, wherein determining the tear volume measurement further comprises:
determining a gaze direction of the one or more eyes of the user; and
applying a correction algorithm to the plurality of images based on the determined gaze direction of the one or more eyes.

8. The electronic device of claim 1, wherein the one or more first criteria are satisfied when a gaze direction of the one or more eyes of the user of the electronic device is within a predetermined angular threshold.

9. The electronic device of claim 1, wherein the one or more programs including instructions for:
determining an aggregate tear volume measurement for the plurality of images of the one or more eyes of the user of the electronic device,
wherein the one or more third criteria include a criterion that is satisfied when the aggregate tear volume measurement is below the tear volume threshold.

10. The electronic device of claim 1, wherein determining the tear volume measurement includes applying an environmental correction algorithm to the plurality of images.

11. The electronic device of claim 1, wherein determining a dry-eye condition comprises:
comparing the determined tear volume measurement with a baseline tear volume measurement, wherein the baseline tear volume measurement is generated according to a process comprising:
in accordance with a determination that one or more environmental criteria are satisfied:
obtaining, via the one or more cameras, a baseline image of the one or more eyes of the user; and
determining a tear volume measurement from the baseline image of the one or more eyes of the user of the electronic device.

12. The electronic device of claim 1, wherein the one or more first criteria include a criterion that is satisfied in accordance with a determination that a power state of the electronic device is a first power state.

13. A method comprising:
at an electronic device in communication with one or more displays and one or more input devices including one or more cameras:
in accordance with a determination that one or more first criteria are satisfied, obtaining, via the one or more cameras, a plurality of images, wherein the plurality of images includes one or more eyes of a user of the electronic device;
in accordance with a determination that one or more second criteria are satisfied, determining a tear volume measurement for one or more of the plurality of images of the one or more eyes of the user of the electronic device; and
in accordance with a determination that one or more third criteria are satisfied, including a criterion that is satisfied when the tear volume measurement is below a tear volume threshold, determining a dry-eye condition associated with the one or more eyes of the user of the electronic device.

14. The method of claim 13, wherein determining the tear volume measurement includes determining a tear meniscus height value from the plurality of images.

15. The method of claim 13, wherein determining the tear volume measurement from the plurality of images includes applying a machine learning model to the one or more of the plurality of images to determine a location of a tear volume in the one or more of the plurality of images.

16. The method of claim 15, wherein determining the tear volume measurement includes:
determining the tear volume measurement in pixels based on the plurality of images; and
converting the determined tear volume measurement from pixels to a distance measurement using a predetermined pixel per inch (PPI) factor.

17. The method of claim 13, wherein the one or more first criteria include a criterion that is satisfied in accordance with a determination that the one or more eyes of the user have blinked, and a criterion that is satisfied in accordance with a determination that a predetermined time interval has passed after the one or more eyes of the user have blinked.

18. The method of claim 13, wherein the one or more first criteria are satisfied when a gaze direction of the one or more eyes of the user of the electronic device is within a predetermined angular threshold, the method further comprising:
determining a gaze direction of the one or more eyes of the user; and
applying a correction algorithm to the plurality of images based on the determined gaze direction of the one or more eyes.

19. The method of claim 13, wherein determining a dry-eye condition comprises:
comparing the determined tear volume measurement with a baseline tear volume measurement, wherein the baseline tear volume measurement is generated according to a process comprising:
in accordance with a determination that one or more environmental criteria are satisfied:
obtaining, via the one or more cameras, a baseline image of the one or more eyes of the user; and
determining a tear volume measurement from the baseline image of the one or more eyes of the user of the electronic device.

20. The method of claim 13, wherein the one or more first criteria include a criterion that is satisfied in accordance with a determination that a power state of the electronic device is a first power state.
